(19) United States
(12) Patent Application Publication
(10) Pub. No.: US 2010/0270386 A1
(43) Pub. Date: Oct. 28, 2010

(54) Bolt on Continuous Rail Joint

(75) Inventors: John W. Mospan, Pittsburgh, PA (US); W. Thomas Urmson, JR., Valencia, PA (US); John M. Downey, Ashland, KY (US); Patrick J. Boario, Allegheny Township, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Portec Rail Products, Inc., Pittsburgh, PA (US)

(21) Appl. No.: 12/750,326

(22) Filed: Mar. 30, 2010

Related U.S. Application Data
(63) Continuation-in-part of application No. 11/504,229, filed on Aug. 15, 2006.
(60) Provisional application No. 60/708,255, filed on Aug. 15, 2005.

(51) Int. Cl. E01B 11/54; E01B 11/02; E01B 11/44; B23P 11/00

(52) U.S. Cl. 238/152; 238/151; 238/164; 29/525.01

(57) ABSTRACT

A rail joint includes a top section and a bottom section. The top section has an upper end and a lower end. The bottom section has an upper portion, an intermediate portion, and a lower portion. The intermediate portion is positioned between the upper portion and the lower portion. The lower end of the top section is secured to the bottom section via at least one of a fastener, a welded joint, and a tongue and groove joint.

### CROSS REFERENCE TO RELATED APPLICATION

This application is a continuation-in-part application claiming priority to U.S. patent application Ser. No. 11/504,229 entitled “Wrap-Around Joint Bar Sleeve Insulator,” filed Aug. 15, 2006, which is incorporated herein by reference in its entirety, claiming priority to U.S. Provisional Application No. 60/708,255 entitled “Wrap-Around Joint Bar Sleeve Insulator,” filed on Aug. 15, 2005.

### BACKGROUND OF THE INVENTION

1. Field of the Invention

The present invention relates to rail joints for joining two railroad rails together and, more particularly, to a wrap-around rail joint insulator sleeve for electrically isolating parts of a rail system from each other.

2. Description of Related Art

The rail system, which permits more than one train to travel on one stretch of track of rail, is generally divided into sections or blocks. The purpose of dividing railroad rails of a rail system into sections is to detect the presence of a train on a section of rail at any given time. Each rail section is electrically isolated from all other sections so that a high electrical resistance can be measured over the rail section when no train is present in that section. When a train enters a rail section, the train will short circuit adjacent railroad rails in which the electrical resistance in the rail section drops thereby indicating the presence of a train.

Railroad rails are generally welded to each other or attached to each other by a steel joint. Referring to FIGS. 1 and 2, a typical railroad rail 10 having a first side 12 and a second side 14 includes a body 16 having a head 18, a web 20, and a base 22 having an upper surface 24 and a lower surface 26. The head 18 is connected to the web 20, which is connected to the base 22. A web recess 30 is defined between the head 18 and the base 22 on each side 12, 14 of the body 16 of the railroad rail 10.

There are many different types and shapes of rail joints. FIG. 1 shows two typical prior art rail joints 32, 34 that can be used to attach railroad rails to each other. The second side 14 of the railroad rail 10 has the prior art rail joint 32 received within the web recess 30 of the railroad rail 10, wherein a bottom surface of the rail joint 32 is adapted to abut against the upper surface 24 of the base 22 of the railroad rail 10. The first side 12 of the railroad rail 10 has the prior art rail joint 34 (oftentimes referred to as a wrap-around rail joint) received within the web recess 30 of the railroad rail 10, wherein the base 22 of the railroad rail 10 coacts with a base section 46 of the rail joint 34. The prior art rail joint 34 generally includes a body 36 having a front side 38 and a back side 40 and defining a head section 42, a web section 44 and a base section 46. The head section 42 depends from the web section 44, which depends from the base section 46. The web section 44 defines a plurality of holes 48 for receiving fasteners (one hole 48 shown in FIG. 12). The base section 46 has an upper portion 50, an intermediate portion 52 and a lower portion 54, wherein the upper portion 50 depends from the intermediate portion 52 which depends from the lower portion 54. A base recess 56 is defined between the upper portion 50 and the lower portion 54 of the base section 46 of the body 36 of rail joint 34. The base 22 of the railroad rail 10 is received within the base recess 56 of the base section 46 of the rail joint 34. The prior art wrap-around rail joint 34 may have many different shapes, for example, such as shown in FIGS. 11 and 12.

In order to electrically isolate adjacent rail sections of a rail system, high-performance, non-metallic joints are typically used. However, these non-metallic joints are very expensive due to the special high-performance materials needed to endure the high tensile and flexural forces exerted on the rail joint. An alternative to a non-metallic rail joint is a steel joint having electrically-insulating material, such as epoxy and insulation material, bonded to a surface of the rail joint for electrically isolating rail sections. These epoxies are well known in the art.

FIG. 2 shows rail joint 34 having material, such as plastic P in contact, but not bonded with portions of its surface for electrically isolate adjacent rail sections of a rail system. The plastic P may be, for example, two plastic sleeve sections, one section positioned adjacent the back side 40 of the head section 42 and a portion of the web section 44, and another section positioned adjacent the back side 40 of the base section 46 and a portion of the web section 44 of the rail joint 34.

It is, therefore, desirable to provide a single insulating sleeve positioned between a wrap-around rail joint and two adjoining railroad rails for electrically isolating the adjoining railroad rails.

### SUMMARY OF THE INVENTION

In one embodiment, a rail joint includes a top section and a bottom section. The top section has an upper end and a lower end. The bottom section has an upper portion, an intermediate portion, and a lower portion. The intermediate portion is positioned between the upper portion and the lower portion. The lower end of the top section is secured to the bottom section via at least one of a fastener, a welded joint, and a tongue and groove joint.

The upper portion and the lower portion may define a recess therebetween. The fastener may secure the lower end of the top section to the upper portion of the bottom section. The upper portion of the bottom section and the lower end of the top section may each define an opening with the fastener extending through the respective openings of the upper portion of the bottom section and the lower end of the top section. The opening in the lower end of the top section may include a threaded portion and the fastener may comprise a screw. The top section may define an opening between the upper end and the lower end. Further, the top section and the bottom section may each include an inner side and an outer side with a rail joint insulator sleeve positioned adjacent the inner sides of the top section and the bottom section.

In another embodiment, a rail joint assembly includes first and second railroad rails and a rail joint secured to the first and second rails. The first rail abuts the second rail and each rail has a head portion, a web portion, and a base portion. The rail joint includes a top section and a bottom section. The top section has an upper end and a lower end. The bottom section has an upper portion, an intermediate portion, a lower portion. The upper portion and the lower portion define a recess therebetween. The recess receives part of the base portion of each rail. The top section is secured to the lower section via at least one of a fastener, a welded joint, and a tongue and groove joint.

The fastener may be secured the lower end of the top section to the upper portion of the bottom section. The upper portion of the bottom section and the lower end of the top section may each define an opening with the fastener extending through the respective openings of the upper portion of the bottom section and the lower end of the top section. Further, the opening of the lower end of the top section may include a threaded portion and the fastener may comprise a screw. The top section may define an opening between the upper end and the lower end with the web portion of each of the rails defining an opening corresponding to the opening in the top section between the upper end and the lower end. The top section and the bottom section may each include an inner side and an outer side with the inner side of the top section having a shape corresponding to a portion of the first and second rails that extends from the head portion to the base portion of the respective rails. The inner side of the bottom section may have a shape corresponding to a portion of the base portion of the first and second rails. A rail joint insulator sleeve may be positioned between the inner sides of the top section and the bottom section and the first and second railroad rails. A recess may be defined between the inner side of the top section and the web portions of the first and second railroad rails.

In a further embodiment, a method of forming a continuous rail joint includes securing a top section of a continuous rail joint to a bottom section of the continuous rail joint via at least one of a fastener, a welded joint, and a tongue and groove joint. The top section has an upper end and a lower end and the bottom section has an upper portion, an intermediate portion, and a lower portion. The lower end of the top section is secured to the bottom section.

The upper portion and the lower portion may define a recess therebetween. The upper portion of the bottom section and the lower end of the top section may each define an opening with the fastener extending through the respective openings of the upper portion of the bottom section and the lower end of the top section. The opening of the lower end of the top section may include a threaded portion, where securing the top section to the bottom section includes inserting the fastener through the opening of the upper portion of the bottom section and engaging the threaded portion of the opening of the lower end of the top section.

In yet another embodiment, a wrap-around rail joint insulator sleeve for a wrap-around rail joint includes a body having a head portion, a web portion, and a base portion. The head portion depends from the web portion which depends from the base portion. The head portion and the base portion are bent in the same direction thereby defining a recess area therebetween. The base portion includes a first section, a spacer section and a second section. The first section depends from the second section via the spacer section, and the first section and the second section define a base portion recess therebetween, which is adapted to receive a base of a railroad rail.

The web portion of the body may define a plurality of slots adapted to receive fasteners. An end of the head portion may be bent toward the base portion thereby defining a first lip that is adapted to fit the contour of a wrap-around rail joint. An end of the second section may be bent away from the first section of the base portion thereby defining a second lip that is adapted to fit the contour of a wrap-around rail joint. The sleeve may comprise an electrically-insulating material, a thermally activated adhesive material, fiberglass, or polyurethane. The sleeve may be capable of supporting a load of at least 100,000 psi tensile strength and a compression strength of at least 70,000 psi. Each side of the sleeve may be impregnated with a thermally activated adhesive material.

In yet a further embodiment, a rail joint assembly includes a pair of abutting railroad rails, a wrap-around rail joint attached to the abutting railroad rails, and a wrap-around rail joint insulator sleeve. The rail joint bar includes a body having a front side and a back side and defines a head section, a web section depending from the head section and a base section depending from the web section. The base section includes an upper portion, an intermediate portion and a lower portion. The upper portion depends from the lower portion via the intermediate portion, and the upper portion and the lower portion define a base portion recess therebetween, which is adapted to receive a base of a railroad rail. The web section has a plurality of holes defined in the body. The holes are adapted to receive fasteners. The wrap-around rail joint insulator sleeve is positioned between the back side of the body of the rail joint and the pair of abutting railroad rails. The insulator sleeve electrically isolates the rail joint from the pair of abutting railroad rails.

The sleeve may include a body having a head portion, a web portion, and a base portion. The head portion depends from the web portion which depends from the base portion. The head portion and the base portion are bent in the same direction thereby defining a recess area therebetween. The base portion includes a first section, a spacer section and a second section. The first section depends from the second section via the spacer section. The first section and the second section define a base portion recess therebetween, which is adapted to receive a base of a railroad rail. The web portion of the body defines a plurality of slots adapted to receive fasteners and the rail joint is attached to the pair of abutting railroad rails via a fastener passing through the hole in the rail joint, the slot in the sleeve and secured to the pair of abutting railroad rails.

In another embodiment, a method for electrically isolating two abutting railroad rails includes providing two railroad rails end to end; positioning an electrically-insulated spacer between the ends of the two railroad rails positioned end to end; placing an electrically-insulated sleeve impregnated with thermally activated adhesive material onto one side of the railroad rails; attaching a rail joint to the one side of the railroad rails via a fastener with the sleeve being positioned between the railroad rails and the rail joint; and heating the sleeve to melt the thermally activated adhesive material whereby the rail joint bonds to the railroad rails. The method may further include tightening the fastener after the thermally activated adhesive material has melted.

### BRIEF DESCRIPTION OF THE DRAWINGS

FIG. 1 is a side elevational view of typical prior art rail joints co-acting with a railroad rail;

FIG. 2 is a side elevational view of the prior art wrap-around rail joint shown in FIG. 1 having plastic sleeves in contact, but not bonded to portions of the rail joint;

FIG. 3 is a front perspective view of a wrap-around rail joint insulator sleeve made in accordance with the present invention;

FIG. 4 is a side elevational view of the sleeve shown in FIG. 3;

FIG. 5 is a front elevational view of the sleeve shown in FIG. 3;

FIG. 6 is a front perspective view of a wrap-around rail joint insulator sleeve made in accordance with a second embodiment of the present invention;

FIG. 7 is a side elevational view of the sleeve shown in FIG. 6;

FIG. 8 is a front elevational view of the sleeve shown in FIG. 6;

FIG. 9 is a side elevational view of a rail joint assembly made in accordance with the present invention;

FIG. 10 is a top plan view of the rail joint assembly shown in FIG. 9;

FIG. 11 is a sectional view of the rail joint assembly taken along lines XI-XI shown in FIG. 9;

FIG. 12 is a sectional view of the rail joint assembly shown in FIG. 11 having adhesive material bonded thereto;

FIG. 13 is a sectional view of a wrap-around rail joint according to one embodiment of the present invention, showing the wrap-around rail joint secured to a rail;

FIG. 14 is a front view of a top section of the wrap-around rail joint of FIG. 13;

FIG. 15 is a detail view and partial cutaway view of area “A” shown in FIG. 14;

FIG. 16 is a side view of a top section of the wrap-around rail joint of FIG. 13;

FIG. 17 is a front view of a bottom section of the wrap-around rail joint of FIG. 13;

FIG. 18 is a detail view and partial cutaway view of area “B” shown in FIG. 17;

FIG. 19 is a side view of a lower portion of the wrap-around rail joint of FIG. 13;

FIG. 20 is a side elevational view of the wrap-around rail joint of FIG. 13, showing the rail joint being supported;

FIG. 21 is a side elevational view of the wrap-around rail joint of FIG. 13, showing the rail joint being suspended;

FIG. 22 is a partial sectional view of a wrap-around rail joint according to another embodiment of the present invention, showing the wrap-around rail joint secured to a rail; and

FIG. 23 is a side elevational view of the wrap-around rail joint of FIG. 22.

### DETAILED DESCRIPTION OF THE INVENTION

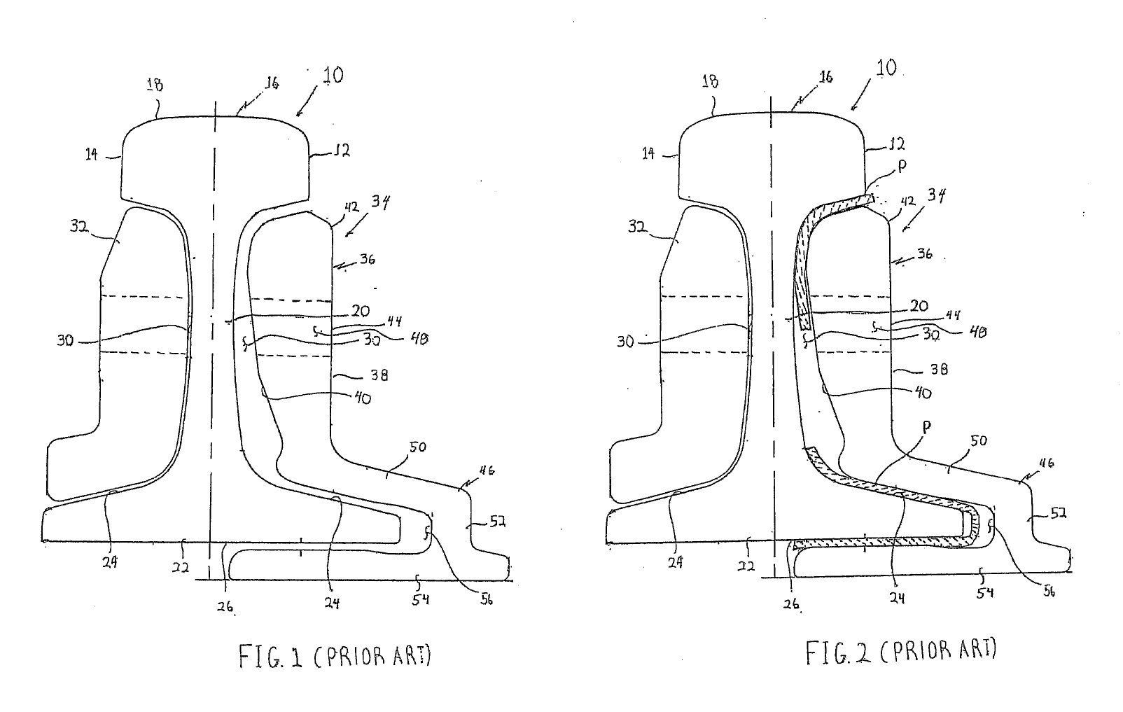

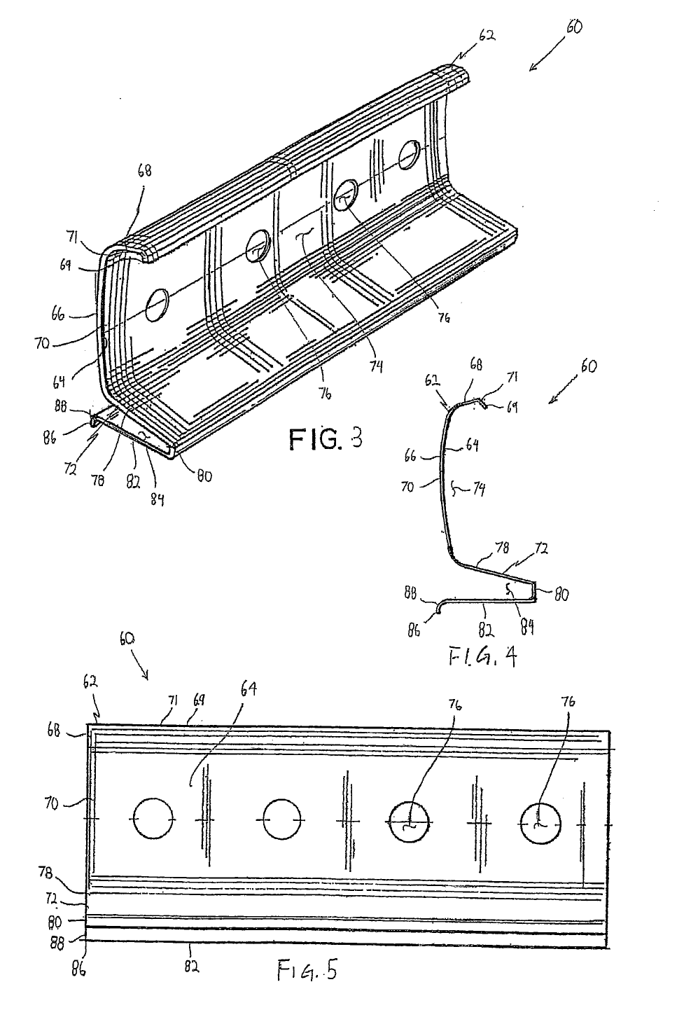

Referring to FIGS. 3-5, the present invention provides for a wrap-around rail joint insulator sleeve 60 for use with prior art wrap-around rail joints 34 (shown in FIGS. 1 and 2) for electrically isolating adjacent rail sections. The sleeve 60 extends partially around the rail joint 34 as shown in FIGS. 11 and 12 to insulate the rail joint 34 from the railroad rails 10, 10′. The sleeve 60, which has an end profile similar to the back side 40 of the prior art rail joint 34 includes a body 62 having a first surface 64 and a second surface 66 and defining a head portion 68, a web portion 70 and a base portion 72. The head portion 68 depends from the web portion 70, which depends from the base portion 72 of the body 62 of the sleeve 60.

Referring to FIGS. 3 and 4, the head portion 68 and the base portion 72 are bent in a direction toward the first surface 64 of the web portion 70, thus defining a recess area 74 therebetween. The head portion 68 having a forward end 69 is bent toward the base portion 72 thus forming an arcuate-shaped first lip 71 adapted to fit the contour of the head section 42 of the body 36 of the rail joint 34 as shown in FIG. 11. The web portion 70 of the body 62 also defines a plurality of slots 76 for receiving fasteners. The base portion 72 of the body 62 includes a first section 78, a spacer section 80 and a second section 82, wherein the first section 78 is connected to the second section 82 via the spacer section 80. The first section 78 extends away from the web portion 70 in the same direction as the head portion 68, and the second section 82 of the base portion 72 extends in a direction opposite that of the first section 78, thereby defining a base portion recess 84 therebetween. The second section 82 having a rearward end 86 is bent thus forming an arcuate-shaped second lip 88 that is adapted to fit the contour of the lower portion 54 of the base section 46 of the body 36 of the rail joint 34 when the base 22 of the railroad rail 10 is received within the base portion recess 84 of the base portion 72 of the body 62 of the sleeve 60 as shown in FIG. 11.

The sleeve 60 can be made of an electrically-insulating material such as a thermally activated adhesive material, fiberglass or polyurethane. A sleeve 60 made of thermally activated adhesive material is preferably capable of creating a bond with the rail joint 34 and the abutting railroad rails 10, 10′. The thermally activated adhesive material can be an adhesive such as sold under 3M™ Thermo-Bond material from 3M available from CYTEC Engineered Materials of 501 West Third Street, Winona, Minn. For example, a sleeve 60 having a thickness of about 0.060 inches can generally create a bond that preferably has a strength of about 4000 psi. The thickness and the length of the sleeve 60 can vary, however, the length of the sleeve 60 should be greater than or equal to the length of the rail joint 34 in order to electrically isolate the rail joint 34 from the railroad rails 10, 10′.

A sleeve 60 made of fiberglass or polyurethane can also provide additional support to the rail joint 34 thus resulting in a longer lasting rail joint assembly. For example, a fiberglass sleeve 60 (e.g., having multiple plies, for example, five plies where adjacent plies strands are arranged transverse to each other) can generally support a load of at least 100,000 psi tensile strength and have a compression strength of at least 70,000 psi. A polyurethane sleeve 60 having a thickness of about 0.060 inches may, for example, preferably have a strength of about 4000 psi. A fiberglass or polyurethane sleeve 60 may also be impregnated with a thermally activated adhesive material, thus providing both bond strength and load support to the rail joint 34. Impregnating a fiberglass or polyurethane sleeve 60 may be accomplished by applying a thermally activated adhesive material onto the first surface 64 and the second surface 66 of the sleeve 60.

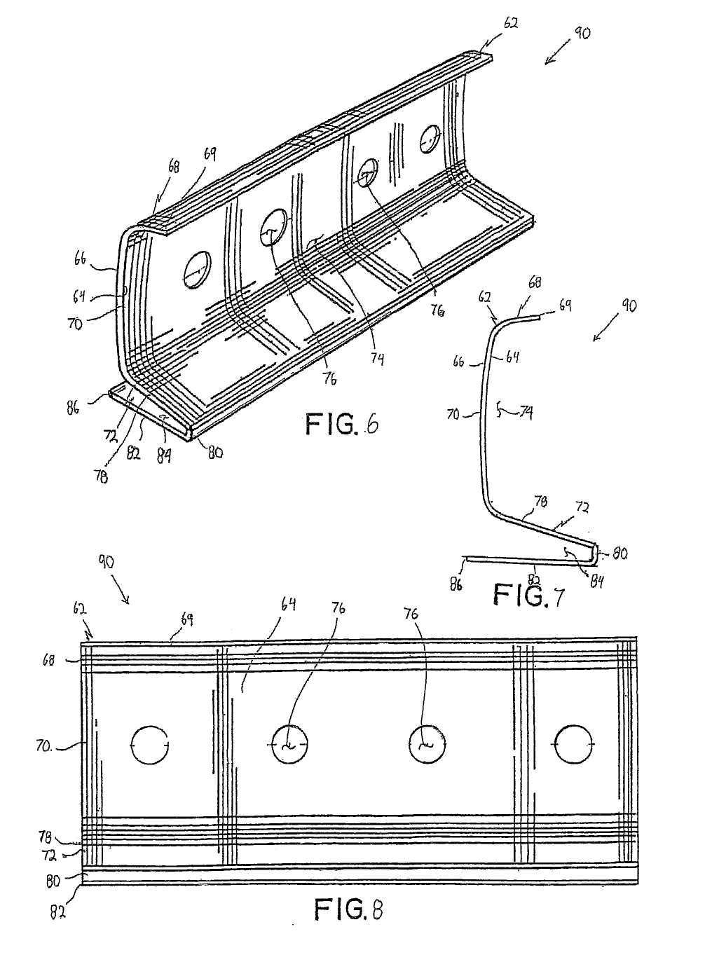

FIGS. 6-8 show another embodiment of a wrap-around rail joint insulator sleeve 90 that is similar to sleeve 60, except for the differences noted below. Like reference numerals are used for like parts. In sleeve 90, the forward end 69 of the head portion 68 and the rearward end 86 of the second section 82 of the base portion 72 are not bent and, therefore, the ends 69, 86 do not have lips 71, 88, respectively, as in sleeve 60.

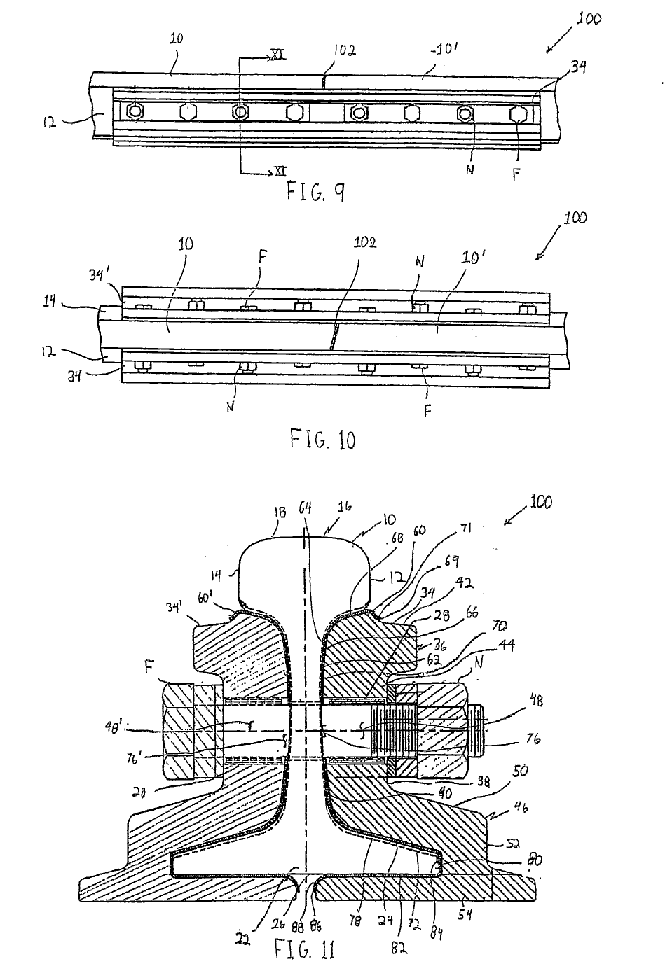

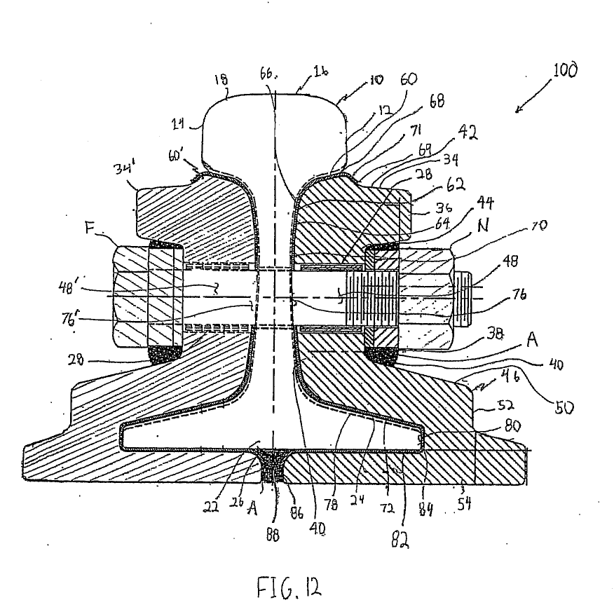

Referring to FIGS. 9-12, the present invention provides for a rail joint assembly 100 that includes a first railroad rail 10 and a second railroad rail 10′ joined end to end and having an electrically-insulated spacer 102 therebetween. The rail joint assembly 100 further includes two prior art wrap-around rail joints 34, 34′ wherein rail joint 34 is fastened to a first side 12 of the railroad rails 10, 10′, and rail joint 34′, which is identical to rail joint 34, is fastened to a second side 14 of the railroad rails 10, 10′ as shown in FIG. 10. Referring to FIGS. 11 and 12, a sleeve 60 as previously described is interposed between the first side 12 of railroad rails 10, 10′ and rail joint 34, and a second sleeve 60′, which is identical to sleeve 60, is interposed between the second side 14 of railroad rails 10, 10′ and rail joint 34′. The holes 48 in rail joint 34 and the slots 76 in sleeve 60 are aligned with the corresponding holes 48′ in rail joint 34′ and the slots 76′ in sleeve 60′. A fastener F, such as a bolt, then passes through each corresponding hole 48, 48′ of rail joints 34, 34′, each corresponding slot 76, 76′ of sleeves 60, 60′, and the respective railroad rail 10, 10′. A nut N may then be threaded at an end of the fastener F. An adhesive A such as silicone or rubber cement may be used in order to prevent shortening of the sleeves 60, 60′ due to moisture as shown in FIG. 12. The sleeves 60, 60′, which have greater strength than typical epoxies, provides for a stronger and more durable electrically-insulated rail joint assembly 100.

The surfaces defining the holes 48, 48′ in rail joints 34, 34′ can be at least partially surrounded by an electrically insulated bushing 28 (shown in phantom in FIGS. 11-12) to prevent the fasteners F from conducting electrical current between railroad rails 10, 10′ and rail joints 34, 34′, thereby ensuring electrical isolation of the rail joint assembly 100. Also, in lieu of the two bushings 28, a single bushing (not shown) may also be used.

The present invention provides for a method of securing two abutting railroad rails 10, 10′ using prior art wrap-around rail joints 34, 34′, wherein the abutting railroad rails 10, 10′ are electrically isolated from one another. First, an end of the first railroad rail 10 is joined to an end of the second railroad rail 10′ and an electrically-insulated spacer 102 is positioned therebetween. Second, a first sleeve 60 impregnated with thermally activated adhesive material is placed on a first side 12 and a second sleeve 60′ impregnated with thermally activated adhesive material is placed on a second side 14 of the railroad rails 10, 10′. Rail joints 34, 34′ are placed over the respective sleeves 60, 60′, wherein the slots 76, 76′ in sleeves 60, 60′ are aligned with the holes 48, 48′ in rail joints 34, 34′, respectively. Next, the rail joints 34, 34′ are attached to the railroad rails 10, 10′ via a fastener F passing through each corresponding hole 48, 48′ of rail joints 34, 34′, each corresponding slot 76, 76′ of sleeves 60, 60′, and the respective railroad rail 10, 10′. A nut N is placed at an end of the fastener F and tightened. The sleeves 60, 60′ are then heated (such as with a torch) to melt the thermally activated adhesive material thereby bonding the rail joints 34, 34′ to the railroad rails 10, 10′. The fastener F can optionally be tightened further before the adhesive material hardens after being melted.

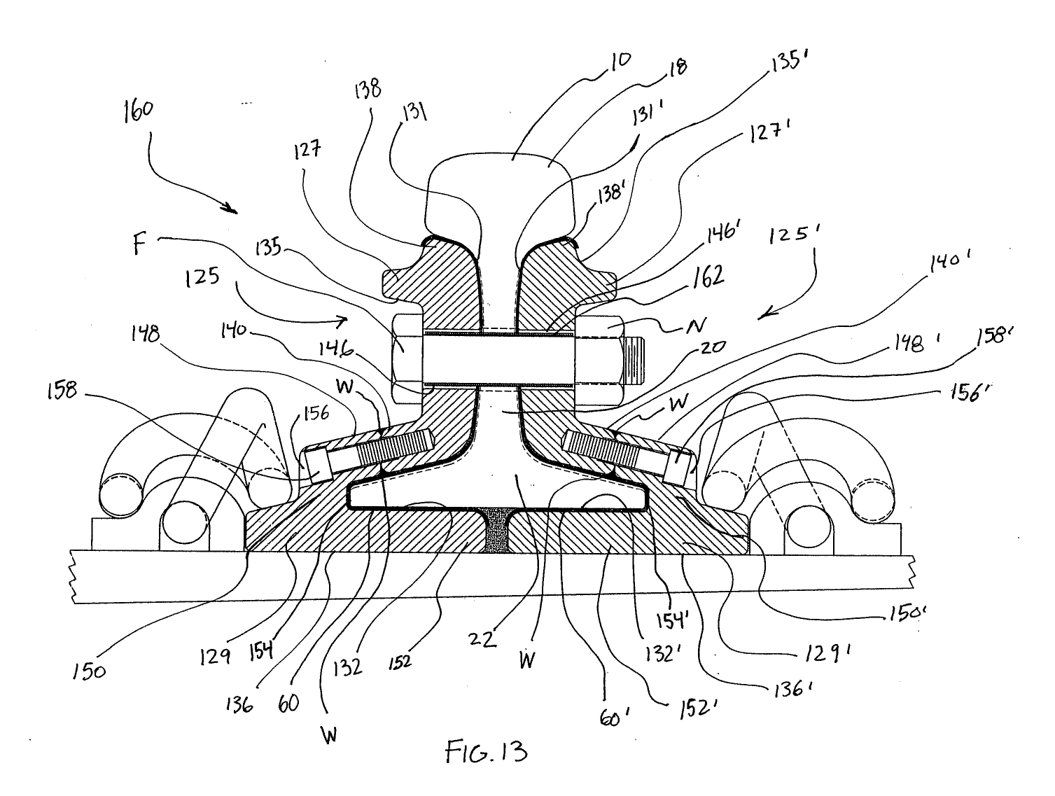

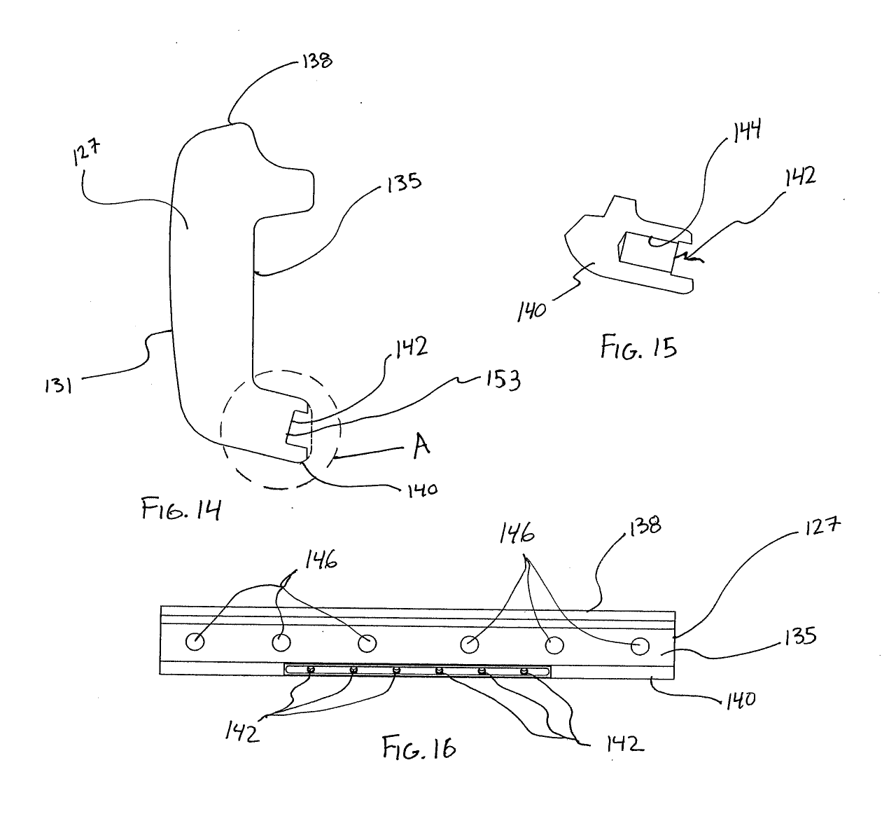

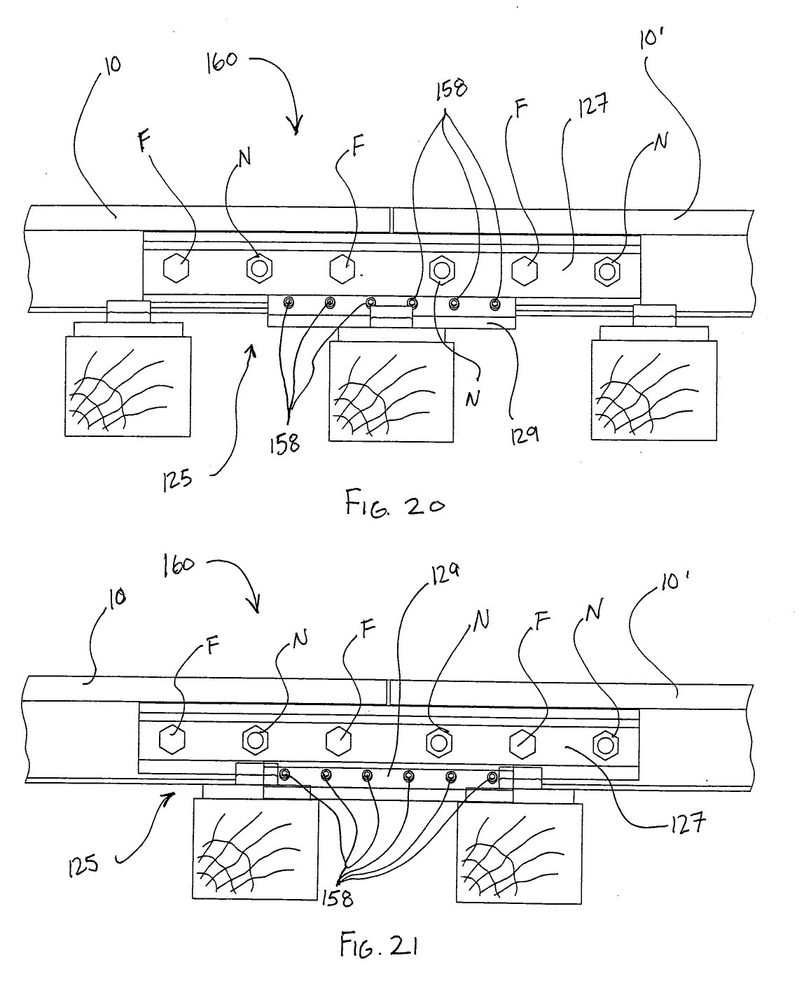

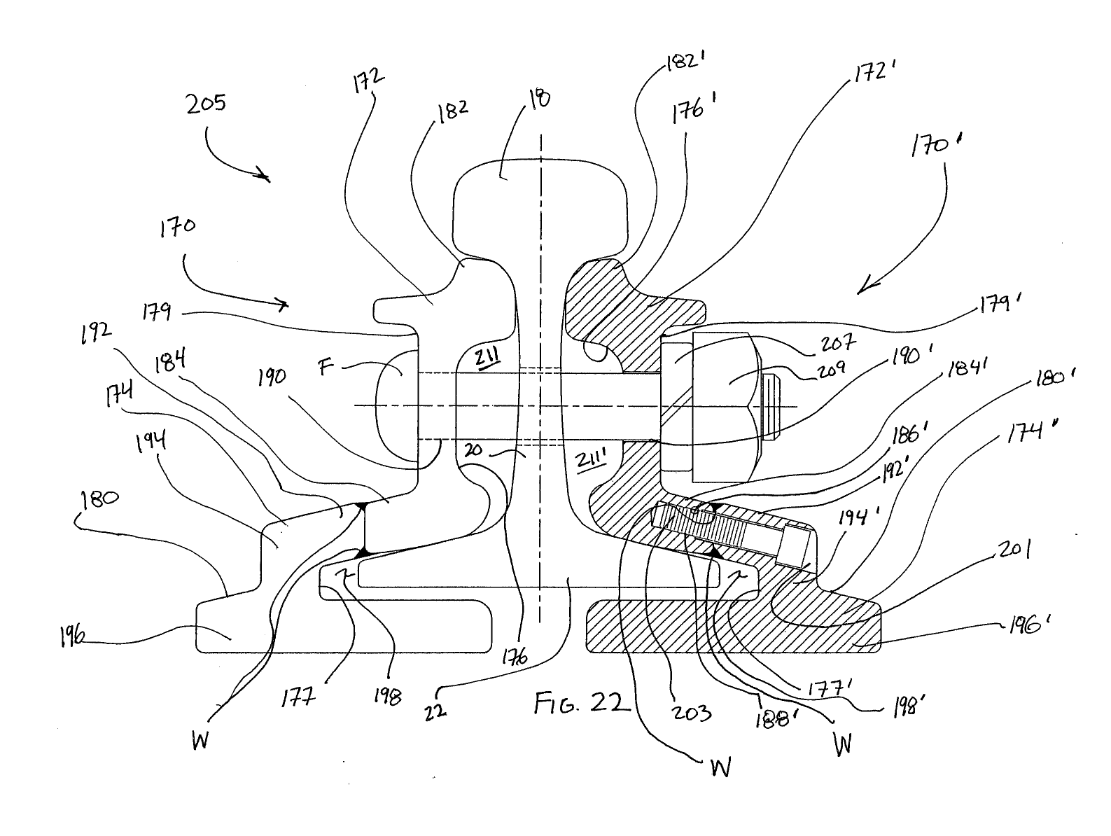

Referring to FIGS. 13-19, one embodiment of a wrap-around or continuous rail joint 125 is disclosed. The wrap-around rail joint 125 includes a top section 127 and a bottom section 129. The top section 127 and the bottom section 129 each include an inner side 131, 132 and an outer side 135, 136. The top section 127 has an upper end 138 and a lower end 140. The lower end 140 of the top section 127 defines a plurality of openings 142 that extend in a substantially transverse direction into the lower end 140 of the top section 127. In particular, as shown in FIG. 16, the lower end 140 of the top section 127 includes six openings 142, although other numbers of openings could be provided. Each of the openings 142 includes a threaded portion 144 for receiving a fastener, such as a screw. The top section 127 also defines a plurality of mounting holes 146 extending substantially transversely through the top section 127 at a position intermediate the upper end 138 and the lower end 140. The bottom section 129 has an upper portion 148, an intermediate portion 150, and a lower portion 152. The intermediate portion 150 is positioned between the upper portion 148 and the lower portion 152 with the upper portion 148 and the lower portion 152 defining a recess 154 therebetween. The upper portion 148 of the bottom section 129 defines a plurality of openings 156 that extend in substantially transverse direction through the upper portion 148 of the bottom section 129. As shown in FIG. 19, the upper portion 148 of the bottom section 129 includes six openings 156, although other numbers of openings could be provided. The openings 156 in the upper portion 148 of the bottom section 129 are aligned with and correspond to the openings 142 in the lower end 140 of the top section 127.

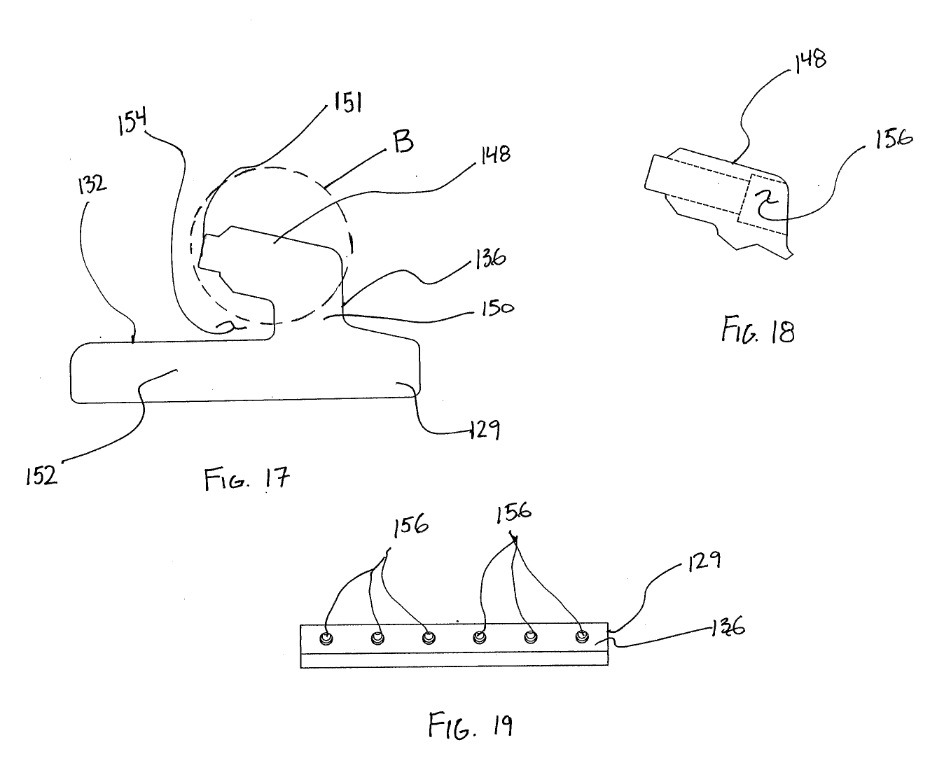

Referring to FIG. 13, the top section 127 is secured to the bottom section 129 via a plurality of fasteners 158, such as screws, and via a welded joint W. Each of the fasteners 158 extends through respective openings 156 in the upper portion 148 of the bottom section 129 and engages respective threaded portions 144 of the openings 142 in the lower end 140 of the top section 127. As shown more clearly in FIG. 18, the openings 156 in the upper portion 148 of the bottom section 129 are counter-bored on the outer side 136 of the bottom section 129 such that the fasteners do not protrude from the bottom section 129 when tightened. As shown in FIG. 13, the upper portion 148 of the bottom section 129 is welded to the lower end 140 of the top section 127 to define the welded joint W. The welded joint W may extend the full length of the bottom section 129 or may extend only a portion of the length of the bottom section 129. Alternatively, the welded joint W may be provided as a plurality of spaced apart welded sections. Furthermore, as shown in FIGS. 14-19, the upper portion 148 of the bottom section 129 defines a projection 151 and the lower end 140 of the top section 127 defines a recess 153 to form a tongue and groove joint therebetween. The cooperating structure 151, 153 of the upper portion 148 of the bottom section 129 and the lower end 140 of the top section 127 further secures the top section 127 to the bottom section 129. The fasteners 158, welded joint W, and tongue and groove joint 151, 153 secure the top section 127 to the bottom section 129 thereby forming the wrap-around rail joint 125.

Referring to FIGS. 13, 20, and 21, two wrap-around rail joints 125, 125′ are shown attached to a first railroad rail 10 and a second railroad rail 10′ forming a rail joint assembly 160. The first rail 10 abuts the second rail 10′. The wrap-around rail joints 125, 125′ are secured to opposite sides of the rails 10, 10′ as discussed above with respect to rail joint assembly 100. In particular, fasteners F, such as bolts, pass through respective mounting holes 146, 146′ in the top sections 127, 127′ of the rail joints 125, 125′ and through respective holes in the first and second rails 10, 10′. A nut N is threaded onto an end of the fastener F. The fastener F is also provided with an electrically insulated bushing 162 that extends through the mounting holes 146, 146′ and the rails 10, 10′ to prevent the fasteners F from conducting electrical current between the railroad rails 10, 10′ and the rail joints 125, 125′. As shown in FIGS. 11-12 and described above, a two-piece bushing may also be provided. The inner sides 131, 131′ of the top sections 127, 127′ have a shape that corresponds to a portion of the first and second rails 10, 10′ that extends from the head portion 18, 18′ to the base portion 22, 22′ of the respective rails 10, 10′.

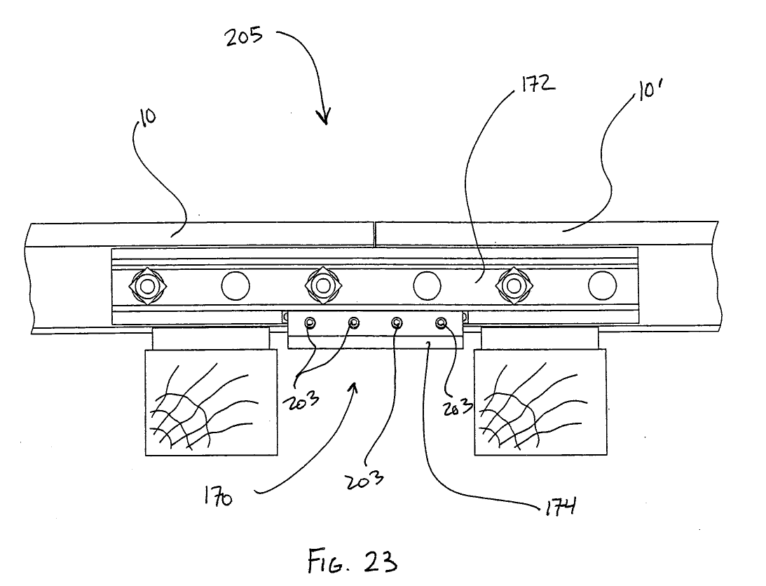

As shown in FIG. 13, the inner sides 132, 132′ of the bottom sections 129, 129′ have a shape that corresponds to a portion of the base portion 22, 22′ of the first and second rails 10, 10′. The recesses 154, 154′ of the bottom sections 129, 129′ receive part of the base portions 22, 22′ of the rails 10, 10′. Further, rail joint insulator sleeves 60, 60′ are positioned adjacent the inner sides 131, 131′, 132, 132′ of the top section 127, 127′ and the bottom section 129, 129′ of the rail joints 125, 125′. More specifically, the sleeves 60, 60′ are positioned between the inner sides 131, 131′, 132, 132′ of the top section 127, 127′ and the bottom section 129, 129′ and the first and second railroad rails 10, 10′ thereby forming the bonded rail joint assembly 160. The rail joints 125, 125′ may be supported (shown in FIG. 20) or the rail joints 125, 125′ may be suspended (shown in FIG. 21). The bottom section 129 is only provided at a center portion intermediate the length of the top section 127 and does not extend the full length of the top section 127. In one embodiment, the length of the bottom section 129 is half of the length of the top section 127. Although not shown, the bottom section 129 may also extend the full length of the top section 127.

Referring to FIGS. 22 and 23, a further embodiment of a wrap-around or continuous rail joint 170 is disclosed. The wrap-around rail joint 170, 170′ is similar to the wrap-around rail joint 125 described above and includes a top section 172, 172′ and a bottom section 174, 174′. The top section 172, 172′ and the bottom section 174, 174′ each include an inner side 176, 176′, 177, 177′ and an outer side 179, 179′, 180, 180′. The top section 172, 172′ has an upper end 182, 182′ and a lower end 184, 184′. As shown in FIG. 22, the lower end 184′ of the top section 172′ defines a plurality of openings 186′ that extend in a substantially transverse direction into the lower end 184′ of the top section 172′. The lower end 184′ of the top section 172′ includes four openings 186′, although other numbers of openings could be provided. Each of the openings 186′ includes a threaded portion 188′ for receiving a fastener, such as a screw. The top section 172, 172′ also defines a plurality of mounting holes 190, 190′ extending substantially transversely through the top section 172, 172′ at a position intermediate the upper end 182, 182′ and the lower end 184, 184′. The bottom section 174, 174′ has an upper portion 192, 192′, an intermediate portion 194, 194′, and a lower portion 196, 196′. The intermediate portion 194, 194′ is positioned between the upper portion 192, 192′ and the lower portion 196, 196′ with the upper portion 192, 192′ and the lower portion 196, 196′ defining a recess 198, 198′ therebetween.

The upper portion 192′ of the bottom section 174′ defines a plurality of openings 201′ that extend in substantially transverse direction through the upper portion 192′ of the bottom section 174′. The upper portion 192′ of the bottom section 174′ includes four openings 201′, although other numbers of openings could be provided. The openings 201′ in the upper portion 192′ of the bottom section 174′ are aligned with and correspond to the openings 186′ in the lower end 184′ of the top section 172′. The top section 172′ is secured to the bottom section 174′ via a plurality of fasteners 203′, such as screws, and via a welded joint W. Each of the fasteners 203′extends through respective openings 201′ in the upper portion 192′ of the bottom section 174′ and engages respective threaded portions 188′ of the openings 186 in the lower end 184′ of the top section 172′. As shown in FIG. 22, the upper portion 192, 192′ of the bottom section 174, 174′ is welded to the lower end 184, 184′ of the top section 172, 172′. The welded joint W may extend the full length of the bottom section 174, 174′ or may extend only a portion of the length of the bottom section 174, 174′. Alternatively, the welded joint W may be provided as a plurality of spaced apart welded sections. Although not shown, the upper portion 192, 192′ of the bottom section 174, 174′ and the lower end 184, 184′ of the top section 172, 172′ may define a tongue and groove joint therebetween as discussed above in connection with rail joint 125.

Referring again to FIGS. 22 and 23, two wrap-around rail joints 170, 170′ are shown attached to first and second abutting railroad rails 10, 10′ thereby forming a rail joint assembly 205. The wrap-around rail joints 170, 170′ are secured to opposite sides of the rails 10, 10′ as discussed above with respect to rail joint assembly 100. In particular, fasteners F, such as bolts, pass through respective mounting holes 190, 190′ in the top sections 172, 172′ of the rail joints 170, 170′ and through respective holes in the first and second rails 10, 10′. A lock washer 207 and nut 209 are threaded onto an end of the fastener F. A recess 211 is defined between the inner sides 176, 176′ of the top sections 172, 172′ and the web portions 20, 20′ of the first and second railroad rails 10, 10′. The inner sides 177, 177′ of the bottom sections 174, 174′ have a shape that corresponds to a portion of the base portions 22, 22′ of the first and second rails 10, 10′. The recesses 198, 198′ of the bottom sections 174, 174′ receive part of the base portions 22, 22′ of the rails 10, 10′. As shown in FIG. 23, the bottom section 174 is only positioned at a center portion intermediate the length of the top section 172 and does not extend the full length of the top section 172. In one embodiment, the length of the bottom section 174 is half of the length of the top section 127. Although not shown, the bottom section 174 may extend the full length of the top section 172.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A rail joint comprising:
a top section having an upper end and a lower end; and
a bottom section having an upper portion, an intermediate portion, and a lower portion, the intermediate portion positioned between the upper portion and the lower portion, the lower end of the top section being secured to the bottom section via at least one of a fastener, a welded joint, and a tongue and groove joint.

2. The rail joint of claim 1, wherein the upper portion and the lower portion define a recess therebetween.

3. The rail joint of claim 1, wherein the fastener secures the lower end of the top section to the upper portion of the bottom section.

4. The rail joint of claim 1, wherein the upper portion of the bottom section and the lower end of the top section each define an opening, the fastener extending through the respective openings of the upper portion of the bottom section and the lower end of the top section.

5. The rail joint of claim 4, wherein the opening in the lower end of the top section includes a threaded portion, and wherein the fastener comprises a screw.

6. The rail joint of claim 1, wherein the top section defines an opening between the upper end and the lower end.

7. The rail joint of claim 1, wherein the top section and the bottom section each include an inner side and an outer side, and wherein the rail joint further comprises a rail joint insulator sleeve positioned adjacent the inner sides of the top section and the bottom section.

8. A rail joint assembly comprising:
first and second railroad rails, the first rail abutting the second rail, each rail having a head portion, a web portion, and a base portion; and
a rail joint secured to the first and second railroad rails, the rail joint including a top section and a bottom section, the top section having an upper end and a lower end, the bottom section having an upper portion, an intermediate portion, and a lower portion, the upper portion and the lower portion defining a recess therebetween, the recess receiving part of the base portion of each rail, the top section being secured to the lower section via at least one of a fastener, a welded joint, and a tongue and groove joint.

9. The rail joint assembly of claim 8, wherein the fastener secures the lower end of the top section to the upper portion of the bottom section.

10. The rail joint assembly of claim 8, wherein the upper portion of the bottom section and the lower end of the top section each define an opening, the fastener extending through the respective openings of the upper portion of the bottom section and the lower end of the top section.

11. The rail joint assembly of claim 10, wherein the opening of the lower end of the top section includes a threaded portion, and wherein the fastener comprises a screw.

12. The rail joint assembly of claim 8, wherein the top section defines an opening between the upper end and the lower end, and wherein the web portion of each of the rails defines an opening corresponding to the opening in the top section between the upper end and the lower end.

13. The rail joint assembly of claim 8, wherein the top section and the bottom section each include an inner side and an outer side, the inner side of the top section having a shape corresponding to a portion of the first and second rails that extends from the head portion to the base portion of the respective rails, the inner side of the bottom section having a shape corresponding to a portion of the base portion of the first and second rails.

14. The rail joint assembly of claim 13, further comprising a rail joint insulator sleeve positioned between the inner sides of the top section and the bottom section and the first and second railroad rails.

15. The rail joint assembly of claim 8, wherein the top section and the bottom section each include an inner side and an outer side, the inner side of the bottom section having a shape corresponding to a portion of the base portion of the first and second rails.

16. The rail joint assembly of claim 15, wherein a recess is defined between the inner side of the top section and the web portions of the first and second railroad rails.

17. A method of forming a continuous rail joint comprising:
securing a top section of a continuous rail joint to a bottom section of the continuous rail joint via at least one of a fastener, a welded joint, and a tongue and groove joint, the top section having an upper end and a lower end, the bottom section having an upper portion, an intermediate portion, and a lower portion, wherein the lower end of the top section is secured to the bottom section.

18. The method of claim 17, wherein the upper portion and the lower portion define a recess therebetween.

19. The method of claim 17, wherein the upper portion of the bottom section and the lower end of the top section each define an opening, the fastener extending through the respective openings of the upper portion of the bottom section and the lower end of the top section.

20. The method of claim 19, wherein the opening of the lower end of the top section includes a threaded portion, and securing the top section to the bottom section includes inserting the fastener through the opening of the upper portion of the bottom section and engaging the threaded portion of the opening of the lower end of the top section.

21. A wrap-around rail joint insulator sleeve for a wrap-around rail joint comprising:
a body having a head portion, a web portion, and a base portion, the head portion depends from the web portion which depends from the base portion, wherein the head portion and the base portion are bent in the same direction thereby defining a recess area therebetween, the base portion comprises a first section, a spacer section and a second section, wherein the first section depends from the second section via the spacer section, and wherein the first section and the second section define a base portion recess therebetween adapted to receive a base of a railroad rail.
